(19) United States
(12) Patent Application Publication
(10) Pub. No.: US 2018/0215314 A1
(43) Pub. Date: Aug. 2, 2018

(54) THE HIDDEN SIDE MIRROR OF VEHICLE

(71) Applicant: Reza SAMIEI, Shiraz (IR)

(72) Inventor: Reza SAMIEI, Shiraz (IR)

(73) Assignee: Emad SADOON, Dartmouth, NS (CA)

(21) Appl. No.: 15/748,374

(22) PCT Filed: Jul. 29, 2015
(86) PCT No.: PCT/IB2015/055729

§ 371 Date: Jan. 29, 2018

(51) Int. Cl. B60R 1/08; B60R 1/074

(52) U.S. Cl. CPC B60R 1/081; B60R 1/074

(57) ABSTRACT

The side mirrors of vehicles are used while turning, changing either the line or the direction to check if other transportation means are found around the vehicle or not. However, some points publicly known as blind spots are not within the sight of drivers. This issue may lead to accidents a well as huge financial or physical damages. Moreover, when the driver tries to park the car or drive it back, a lot of spots are hidden from his sight which causes the vehicles to hit some obstacle or etc. In the present invention, in order to overcome the mentioned problems, a hidden mirror has been used which can help the driver in two conditions if necessary. First of all, when turning left or right or changing the direction the hidden mirror comes out of the frame of side mirrors automatically and the area which is not covered by the side mirror is shown to the driver. The second mode is when the vehicle is driven back. In this manner, the same mirror is displaced and shows the area of rear wheel to the driver and helps the driver to drive backward with a better vision scope.

### TECHNICAL FIELD OF THE INVENTION

The technical field of this invention is related to designing vehicle segments applying mechanical and electronic science.

### Technical Problem

The side mirrors of vehicles are used while turning, changing either the line or the direction to check if other transportation means are found around the vehicle or not. However, since the vision scope of current mirrors is restricted, some points publicly known as blind spots are not within the sight of drivers. This issue may lead to accidents a well as huge financial or physical damages.

Moreover, when the driver tries to park the car or drive it back, a lot of spots are hidden from his sight which causes the vehicles to hit some obstacle or etc.

### BACKGROUND OF THE INVENTION

To remove the mentioned problems in the trucks, two mirrors have been used but this method is not desirable for cars since they deform the aerodynamic system and create an inappropriate appearance. In the other method, the inside mirror is designed in a bigger size. However, when the driver turns left, he tends to look right and use the side mirror on the left hand; therefore the simultaneous usage of inside mirror is difficult. In addition, this kind of mirror cannot also be used to see the vehicle sides while driving backward.

The past developments of this segment mostly included the outward alterations and in the recent years, in addition to its apparent beauty, other changes include stabilizing mirror frame, mobilizing the mirror inside the frame, mirror heating, adapting the mirror inside the vehicle manually and then electrifying and its automatic adjustments. However, none of these changes has had a considerable effect on increasing the vision scope and this issue can be easily realized in the current advanced vehicles a short while after driving. Most of the changes are beauty centered. It is worth mentioning that the cameras and monitors utilized in the vehicles do not replace the mirror and just increase the final price of the vehicle.

### SUMMARY OF THE INVENTION

In the present invention, in order to overcome the mentioned problems, a hidden mirror has been used which can help the driver in two conditions if necessary.

First of all, when turning left or right or changing the direction and after turning on the signal lights, the hidden mirror comes out of the frame of side mirrors automatically and the area which is not covered by the side mirror is shown to the driver. After changing direction is finished and signal lights are turned off, the mirrors automatically return to their first position.

Furthermore, while required, the driver can bring each of the hidden mirrors out of its place by pressing the bottom on the dashboard. The mirror turns back to its place automatically after some moments. If the driver requires the hidden mirror to be open for a longer time, then he must press the button on the dashboard twice. In doing so, the mirror stays open as long as the vehicle keeps going.

The second mode in which the hidden mirror helps the driver is when the vehicle is driven back. In this manner, after the rear gear is put in the position of backward movement, the same mirror is displaced and shows the area of rear wheel to the driver and helps the driver to drive backward with a better vision scope.

This time again, the mirror returns to its first place after the gear comes out of the backward movement position. If the driver requires using the mirror without changing the gear position, he can use the bottoms installed on the dashboard.

### BRIEF DESCRIPTION OF THE DRAWINGS

FIG. 1: hidden mirror showing rear wheel while the automobile drives backward

FIG. 2: hidden mirror showing blind spots while the automobile turns right or left

FIG. 3: hidden mirror is closed

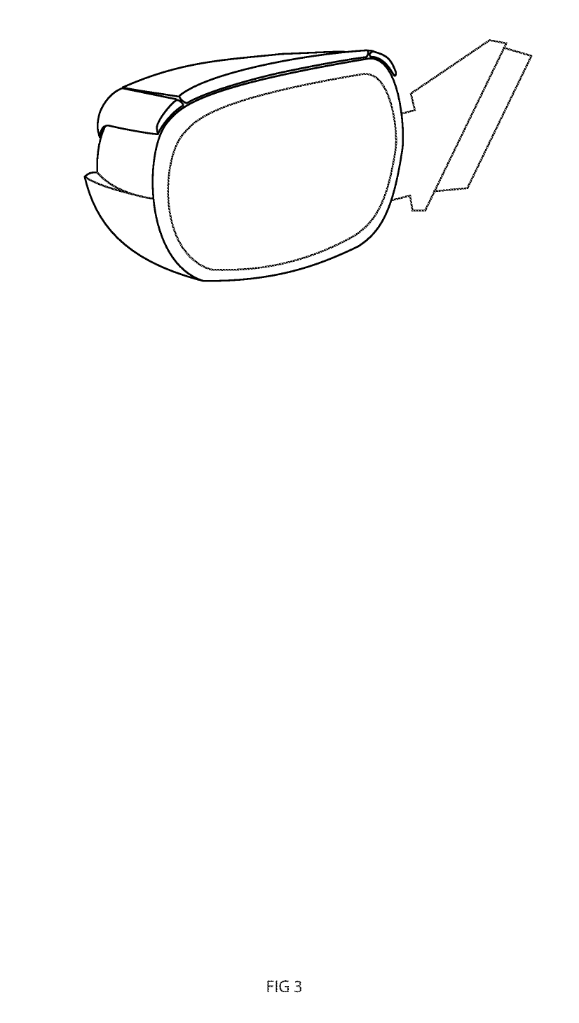

### DETAILED DESCRIPTION OF THE DRAWING

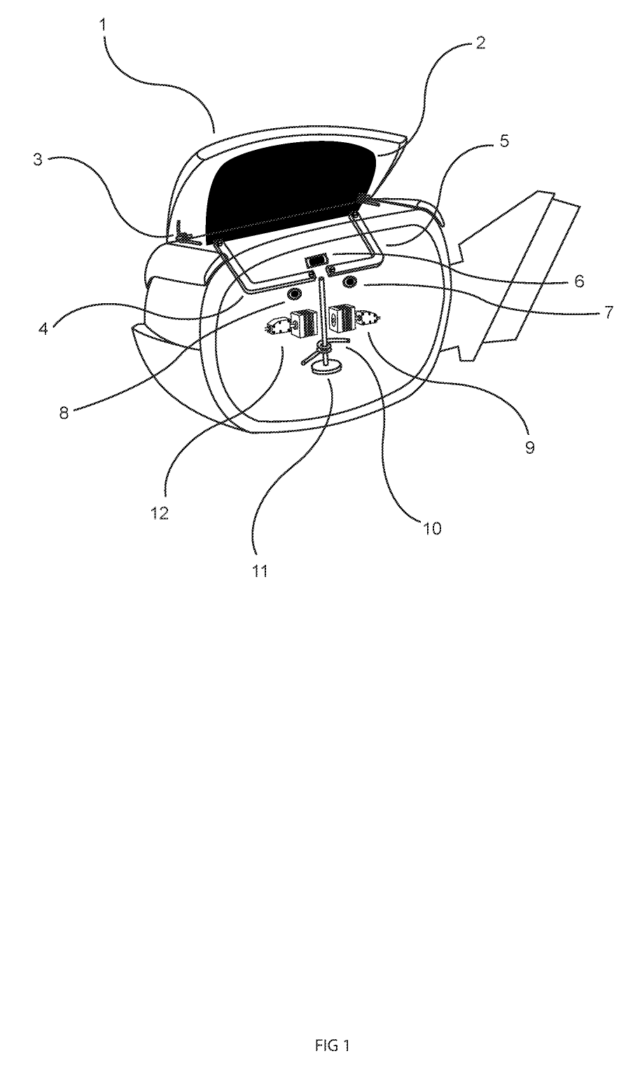

FIG. 1: a cover 1 is placed above the mirror which protects the unstable mirror and it gets opened from the hinged side to help the mirror come out of its container.

Under the cover, there is a convex mirror 2 the size of which can be different depending on the type of vehicle. In figure number 1, this mirror is placed in a way that can show the rear wheels to the driver and secures a safe backward movement. The cover is attached to the mirror body through two springs and a hinge 3.

The engine transfers its power to the mirror through two levers. The first lever 4 is responsible to transfer engine movement to the mirror and place the mirror direction in the way that the blind spots can be seen. The second lever 5 is responsible to transfer engine movement to the mirror and place the mirror direction in a way that the side blind spots can be seen while using the signal light.

The engine movement is controlled by sensor or micro-switch 6. These sensors stop the engines when the mirrors are closed. Number 7 illustrates the sensor which controls engine 1 movement in an open mode. Number 8 illustrates the sensor which controls engine 2 movement in an open mode. Step motor can be utilized instead of sensor or micro-switch to control the engine.

This system uses two gear box engines. The first gear box engine 9 is responsible to place the unstable mirrors in a way to cover the side blind points in signal mode.

Number 10 is the spring which connects the mirror to the base and returns it to a straight position.

Number 11 displays the holding base and the device connecting mirror and spring to its main body.

Number 12 is the second gear box engine which is responsible to place the unstable mirrors in a way to cover the rear and low blind points in park or rear gear mode.

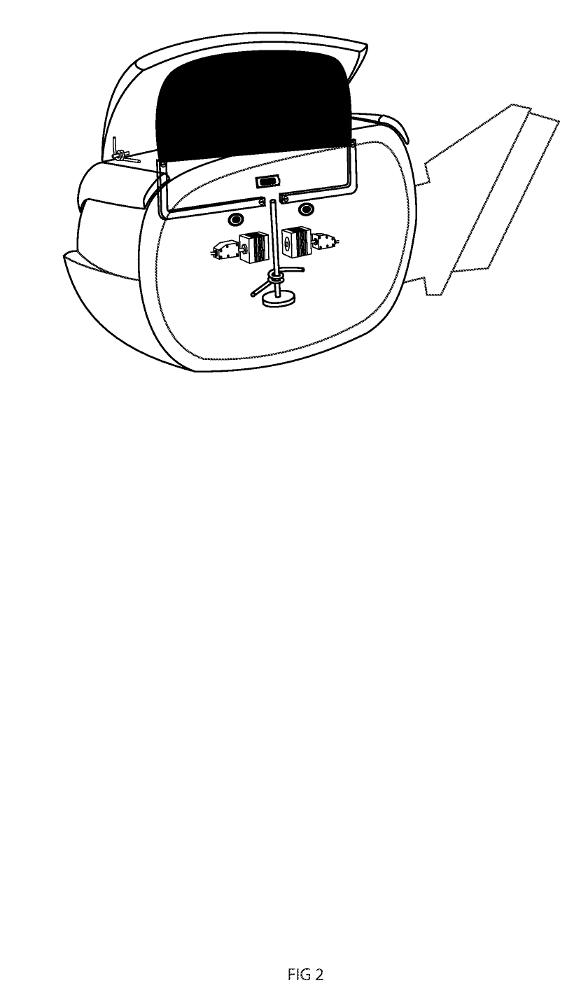

FIG. 2:

In this figure, the angle of mirror is shown in a way that can show the blind spots to the driver while turning right or left. This helps the driver to have a safer line change.

The movement of hidden mirror can be designed in a linear, vertical or . . . way. This system is controlled by an electronic circuit which is fed by 12 voltage electricity of vehicle and includes the input, rear gear, and output of steering toward each mirror. The circuits are connected to the mirrors by interface wires. Moreover, manual control chassis is installed in the dashboard which helps the driver to choose the manual mode.

### The Advantages of Invention

1. Creating comfort and security for the drivers and passengers.
2. Prohibiting physical and financial damages
3. The possibility to be installed on the manual and electric mirrors
4. Functionality in both automatic and manual way
5. Improving the general beauty of vehicle

1. The hidden side mirror of the Vehicle with the possibility of showing the blind spots to the driver while changing direction or driving backward

2. According to claim 1: after turning on the signal lights, the hidden mirror comes out of the frame of side mirrors automatically.

3. According to claim 2: the area which is not covered by the side mirror is shown to the driver with the hidden mirror.

4. According to claim 2: After changing direction is finished and signal lights are turned off, the mirrors automatically return to their first position.

5. According to claim 1: the driver can bring each of the hidden mirrors out of its place by pressing the bottom on the dashboard.

6. According to claim 5: The mirror turns back to its place automatically after some moments.

7. According to claim 5: If the driver requires the hidden mirror to be open for a longer time, then he must press the button on the dashboard twice. In doing so, the mirror stays open as long as the vehicle keeps going or if the driver wants the mirror to be closed, he need to press the button again.

8. According to claim 1: when the driver puts the rear gear in the position of backward movement, the mirror is displaced and shows the area of rear wheel to the driver.

9. According to claim 8: The mirror turns back to its place after the gear comes out of the back gear position.

10. According to claim 8: If the driver requires the hidden mirror to be open for a longer time, then he must press the button on the dashboard twice. In doing so, the mirror stays open as long as the vehicle keeps going or if the driver wants the mirror to be closed, he need to press the button again.

11. According to claim 1: a cover is placed above the mirror which protects the hidden mirror and it gets opened from the hinged side.

12. According to claim 1: the size of mirror can be different depending on the type of vehicle.

13. According to claim 1: the cover is attached to the mirror body through two springs and a hinge 3.

14. According to claim 1: the engine transfers its power to the mirror through two levers.

15. According to claim 14: the first lever is responsible to transfer engine movement to the mirror and place the mirror direction in the way that the blind spots can be seen.

16. According to claim 14: the second lever is responsible to transfer engine movement to the mirror and place the mirror direction in a way that the side blind spots can be seen.

17. According to claim 1: the engine movement is controlled by sensor or micro-switch.

18. According to claim 17: these sensors stop the engines when the mirrors are closed.

19. According to claim 17: step motor can be utilized instead of sensor or micro-switch to control the engine.

20. According to claim 1: this system uses two gear box engines.

21. According to claim 20: the first gear box engine is responsible to place the unstable mirrors in a way to cover the side blind points in signal mode.

22. According to claim 20: the second gear box engine which is responsible to place the unstable mirrors in a way to cover the rear and low blind points in park or rear gear mode.

23. According to claim 1: the movement of hidden mirror can be designed in a linear, vertical way.
